(19) United States
(12) Patent Application Publication
(10) Pub. No.: US 2017/0188093 A1
(43) Pub. Date: Jun. 29, 2017

(54) METHOD AND ELECTRONIC DEVICE FOR GRADING-BASED PROGRAM PLAYING BASED ON FACE RECOGNITION

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Feng Pan, Tianjin (CN)

(21) Appl. No.: 15/245,581

(22) Filed: Aug. 24, 2016

Related U.S. Application Data
(63) Continuation of application No. PCT/CN2016/088854, filed on Jul. 6, 2016.

(30) Foreign Application Priority Data
Dec. 28, 2015 (CN) 201511009782.6

(51) Int. Cl. H04N 21/4415; H04N 21/462; H04N 21/258; H04N 21/472; H04N 21/431; H04N 21/475; H04N 21/45; H04N 21/482

(52) U.S. Cl. CPC H04N 21/4415; H04N 21/4532; H04N 21/462; H04N 21/4826; H04N 21/47202; H04N 21/4316; H04N 21/4758; H04N 21/25875

(57) ABSTRACT

Disclosed are a grading-based program playing method based on face recognition and an electronic device. The method includes: detecting a program on-demand instruction input by a user, enabling a face recognition function to collect a face image of the current user, and generating age data according to the face image of the current user; determining a program corresponding to the program on-demand instruction, calling predetermined grading-based playing settings, and acquiring an age data interval corresponding to the program; and judging whether the age data falls within the age data interval, if the age data falls within the age data interval, normally playing the program, and otherwise, not playing the program and sending a prompt to the user. According to the embodiments of the present disclosure, a simple and highly-efficient grading control-based program playing effect is achieved.

### CROSS REFERENCE TO RELATED APPLICATIONS

This application is a continuation of International Application No. PCT/CN2016/088854, filed on Jul. 6, 2016, which is based upon and claims priority to Chinese Patent Application No. 201511009782.6, filed on Dec. 28, 2015, the entire contents of which are incorporated herein by reference.

### TECHNICAL FIELD

The disclosure relates to the technical field of program playing control, and more particularly, to a method and electronic device for grading-based program playing based on face recognition.

### BACKGROUND

Smart multimedia terminals including smart televisions, smart phones and the like play a more and more important role in the life of people nowadays. Based on powerful functions of the smart multimedia terminals, users may request anytime and anywhere their interested programs for watching. The above program playing manner brings great convenience for the users, but is also subjected to some problems. The problem of grading-based program playing is especially prominent. The conventional grading-based playing manner is a grading mechanism for the programs. That is, age intervals which programs are suitable for are determined are defined according to content of the programs. This mechanism is intended to serving the audience, especially to protect the children and young persons. In the face of commercial benefits, the grading mechanism fails to work as desired. Many video makers and manufacturers spare no effort to prompting and pushing porn and violent programs to the young persons and children. Perfect grading mechanisms have been formulated in such countries as the United States, Britain, Japan and the like. However, in most countries, the grading mechanisms are not enforced in law, but only give restrictions in the industry. With the grading mechanisms, a prompt is only given to the audience, but the audience have the rights to choose to achieve self-protection by the audience themselves. As a result, the protection effect is very limited.

### SUMMARY

In view of the above, an objective of the present disclosure is to provide a grading-based program playing method based on face recognition and an electronic device thereof, which are capable of implementing effective and highly-efficient grading-based playing of programs on a terminal device.

In one aspect, embodiments of the present disclosure provide a grading-based program playing method based on face recognition, which is applied to a smart terminal and includes:

detecting a program on-demand instruction input by a user, enabling a face recognition function to collect a face image of the current user, and generating age data according to the face image of the current user;

determining a program corresponding to the program on-demand instruction, calling predetermined grading-based playing settings, and acquiring an age data interval corresponding to the program; and

judging whether the age data falls within the age data interval, if the age data falls within the age data interval, normally playing the program, and otherwise, not playing the program and sending a prompt to the user.

Optionally, upon the collecting a face image of the current user, the method further includes:

retrieving in a database to check whether face image storage data matching with the face image of the current user is present, if the face image storage data matching with the face image of the current user is present, further acquiring age data associated with the face image storage data, and otherwise, generating age data according to the face image of the current user.

Optionally, upon the generating age data according to the face image of the current user, the method further includes:

establishing an association between the face image of the current user and the age data, and storing the association into the database as the face image storage data.

Optionally, upon the generating age data according to the face image of the current user, the method further includes:

popping up a prompt box to display the age data to the user; and

receiving an edit instruction input by the user, and re-determining the age data.

Optionally, upon the popping up a prompt box to display the age data to the user, the method further includes:

judging whether the age data is greater than a predetermined threshold, if the age data is greater than the predetermined threshold, further receiving the edit instruction input by the user, and otherwise, denying receiving the edit instruction input by the user.

Optionally, upon the not playing the program and sending a prompt to the user, the method further includes:

calling a grading recommendation policy, and generating a recommended program list according to the age data and displaying the recommended program list.

Optionally, the method further includes:

receiving a grading vote of the user for the program, and uploading the grading vote to a server, the grading vote being used for the server to generate latest grading-based playing settings; and

periodically downloading the latest grading-based playing settings from the server at a predetermined time interval.

In a second aspect, embodiments of the present disclosure provide a non-volatile computer storage medium which stores computer executable instructions, wherein the computer executable instructions are executed to:

detect a program on-demand instruction input by a user, enable a face recognition function to collect a face image of the current user, and generate age data according to the face image of the current user;

determine a program corresponding to the program on-demand instruction, call predetermined grading-based playing settings, and acquire an age data interval corresponding to the program; and

In the technical solution according to the embodiments of the present disclosure, upon the detecting a program on-demand instruction input by a user, enabling a face recognition function to collect a face image of the current user, and generating age data according to the face image of the current user, the computer executable instructions are further executed to:

retrieve in a database to check whether face image storage data matching with the face image of the current user is present, if the face image storage data matching with the face image of the current user is present, further acquire age data associated with the face image storage data, and otherwise, generate age data according to the face image of the current user.

In the technical solution according to the embodiments of the present disclosure, the computer executable instructions are further executed to:

store, according to a storage instruction, an association between the face image of the current user and the age data into the database as the face image storage data.

In the technical solution according to the embodiments of the present disclosure, the computer executable instructions are further executed to:

pop up a prompt box to display the age data to the user, and re-determine the age data according to an edit instruction input by the user.

In the technical solution according to the embodiments of the present disclosure, the computer executable instructions are further executed to:

judge, according to a judge instruction, whether the age data is greater than a predetermined threshold, if the age data is greater than the predetermined threshold, further receive the edit instruction input by the user, and otherwise, deny receiving the edit instruction input by the user.

In the technical solution according to the embodiments of the present disclosure, the computer executable instructions are further executed to:

call a grading recommendation policy according to a recommend instruction, and generate a recommended program list according to the age data and display the recommended program list.

In the technical solution according to the embodiments of the present disclosure, the computer executable instructions are further executed to:

receive a grading vote of the user for the program, and upload the grading vote to a server, the grading vote being used for the server to generate latest grading-based playing settings; and periodically download the latest grading-based playing settings from the server at a predetermined time interval.

In a third aspect, embodiments of the present disclosure further provide an electronic device, configured to perform the grading-based program playing method based on face recognition, including:

at least one processor; and

at least one memory communicably connected to the at least one processor; wherein

the memory stores instructions executable by the at least one processor, wherein, the instructions, when being executed by the at least one processor, causes the at least one processor to:

detect a program on-demand instruction input by a user, enable a face recognition function to collect a face image of the current user, and generate age data according to the face image of the current user;

determine a program corresponding to the program on-demand instruction, call predetermined grading-based playing settings, and acquire an age data interval corresponding to the program; and

judge, according to a play instruction whether the age data falls within the age data interval, if the age data falls within the age data interval, normally play the program, and otherwise, not play the program and send a prompt to the user.

In the technical solution according to the embodiments of the present disclosure, upon the detecting a program on-demand instruction input by a user, enabling a face recognition function to collect a face image of the current user, and generating age data according to the face image of the current user, the at least one processor is further caused to:

retrieve in a database to check whether face image storage data matching with the face image of the current user is present, if the face image storage data matching with the face image of the current user is present, further acquire age data associated with the face image storage data, and otherwise, generate age data according to the face image of the current user.

In the technical solution according to the embodiments of the present disclosure, the at least one processor is further caused to:

store, according to a storage instruction, an association between the face image of the current user and the age data into the database as the face image storage data.

In the technical solution according to the embodiments of the present disclosure, the at least one processor is further caused to:

pop up a prompt box to display the age data to the user, and re-determine the age data according to an edit instruction input by the user.

In the technical solution according to the embodiments of the present disclosure, the at least one processor is further caused to:

judge, according to a judge instruction, whether the age data is greater than a predetermined threshold, if the age data is greater than the predetermined threshold, further receive the edit instruction input by the user, and otherwise, deny receiving the edit instruction input by the user.

In the technical solution according to the embodiments of the present disclosure, the at least one processor is further caused to:

call a grading recommendation policy according to a recommend instruction, and generate a recommended program list according to the age data and display the recommended program list.

In the technical solution according to the embodiments of the present disclosure, the at least one processor is further caused to:

receive a grading vote of the user for the program, and upload the grading vote to a server, the grading vote being used for the server to generate latest grading-based playing settings; and periodically download the latest grading-based playing settings from the server at a predetermined time interval.

As seen from the above, with the grading-based program playing method based on face recognition and the electronic device thereof according to the embodiments of the present disclosure, a face image of a current user is acquired by using a face recognition service and age data of the current user is also acquired, it is judged, according to the age data and predetermined grading-based playing settings, whether the current user is suitable for watching a program which is demanded by the user, and the program is not played when the user is unsuitable for watching the program. In this way, a simple and highly-efficient grading control-based program playing effect is achieved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a grading-based program playing method based on face recognition according to one embodiment of the present disclosure;

FIG. 2 is a schematic flowchart illustrating a grading-based program playing method based on face recognition according to another embodiment of the present disclosure;

FIG. 3 is a schematic structural diagram illustrating a grading-based program playing apparatus based on face recognition according to one embodiment of the present disclosure; and

FIG. 4 is a schematic structural diagram illustrating hardware of an electronic device for performing the grading-based program playing method based on face recognition according to an embodiment of the present disclosure.

### DETAILED DESCRIPTION

To make the objectives, technical solutions, and advantages of the present disclosure clearer, the present disclosure is described in detail with reference to the accompanying drawings and specific embodiments.

It should be noted that, the terms “first”, “second” and “third” used in the embodiments of the present disclosure are two non-identical entities or non-identical parameters having the identical name. It is apparent that the terms “first”, “second” and “third” are given herein for illustration convenience, and shall not be construed as limiting the embodiments of the present disclosure. Such terms are not described in the following embodiments any further.

Embodiments of the present disclosure provide a grading-based program playing method based on face recognition. The method according to the embodiments of the present disclosure is applied to a smart television, a smart phone, a computer, a tablet computer and the like commonly used smart terminals. A face recognition functional module needs to be configured on these terminals, which is capable of providing a face recognition function for users. Face images of the users are collected by using cameras of the smart terminals, the collected face images are analyzed and processed, and thus specific relevant data such as ages, agendas, emotions and the like may be further acquired. The relevant content of the face recognition function pertains to the related art, which is thus not described in the embodiments of the present disclosure any further.

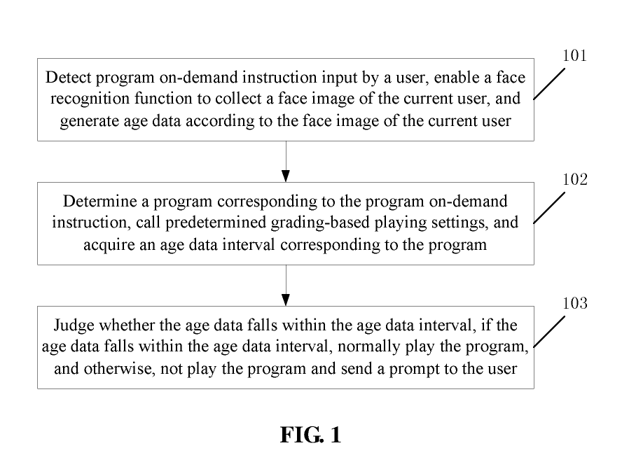

Referring to FIG. 1, a schematic flowchart illustrating a grading-based program playing method based on face recognition according to one embodiment of the present disclosure is given.

The grading-based program playing apparatus based on face recognition includes the following steps:

Step 101: A program on-demand instruction input by a user is detected, a face recognition function is enabled to collect a face image of the current user, and age data is generated according to the face image of the current user.

When a smart terminal is in a normal working state, user behaviors are detected in real time. When it is detected that the user inputs a program on-demand instruction via an APP or a website page and requests to play a program, a face recognition functional module of the smart terminal is enabled to perform face recognition for the user using the smart terminal. Firstly, the face image of the current user is collected by using a camera of the smart terminal, and then the age data of the current user is calculated by using a predetermined face recognition algorithm based on the face image of the current user. The age data herein is generally a specific age value, for example, 20.

Step 102: A program corresponding to the program on-demand instruction is determined, predetermined grading-based playing settings are called, and an age data interval corresponding to the program is acquired.

The corresponding program, i.e., a program which the user desires to watch, is determined according to the detected program on-demand instruction input by the user in the above step. Then, the locally stored grading-based playing settings are called, wherein the grading-based playing settings store a plurality different “program—age data interval” data groups, and each “program—age data interval” indicates an age interval which the program is suitable for corresponding to a program. In this step, after the grading-based playing settings are called, according to the previously determined program which the user desires to watch, a “program—age data interval” data group including the program is searched in the grading-based playing settings, and then the age data interval corresponding to the program is acquired according to the searched data group.

It should be noted that in this embodiment, the “program” in the “program—age data interval” data group does not narrowly refers to a specific program name, and may refer to a specific program type. This is because the network may provide a large number of programs to be played for the user, determining the age data interval according to the specific program name may cause great data processing volume. Therefore, to save the memory and processing resources, the age data interval may be determined according to the program type. The programs currently available on the network generally include tags identifying some basic attributes thereof, and the program types may be conveniently acquired by reading the specific programs. Therefore, in this step, when the age data interval is determined according to the program type, the corresponding program is determined according to the program on-demand instruction input by the user, and thus the program type of the program is acquired by reading the tag of the program. Afterwards, the grading-based playing settings are called, and the age data interval is acquired according to the program type. For example, the age data interval corresponding to an adult program is greater than 18 years old.

Step 103: It is judged whether the age data falls within the age data interval, if the age data falls within the age data interval, the program is normally played, and otherwise, the program is not played and a prompt is sent to the user.

In this step, the age data of the user acquired in the above step and the age data interval of the program which the user desires to watch are compared to judge whether the age data falls within the age data interval. When it is judged that the age data falls within the age data interval, it indicates that the program which the user desires to watch is suitable for watching, and the program is normally played for the user. When it is judged that the age data does not fall within the age data interval, it indicates that the program which the user desires to watch is not suitable for watching, and the program will not be normally played; and a prompt is sent to the user in a prompting manner of text, audio or a combination thereof, such that the user knows that the program which the user desires to watch is not suitable for watching.

Accordingly, with the grading-based program playing method based on face recognition according to the embodiment of the present disclosure, age data of a user is acquired by using the face recognition technology; it is judged, based on the age data of the user, whether a program which the user desires to watch is suitable for watching; and if the program is not suitable for watching, the program will not be played. This implements program grading-based playing, provides an effective protection for users within a specific age interval during watching programs, especially the young persons and children, and prevents such users from watching some porn and violent programs which affects health growth thereof.

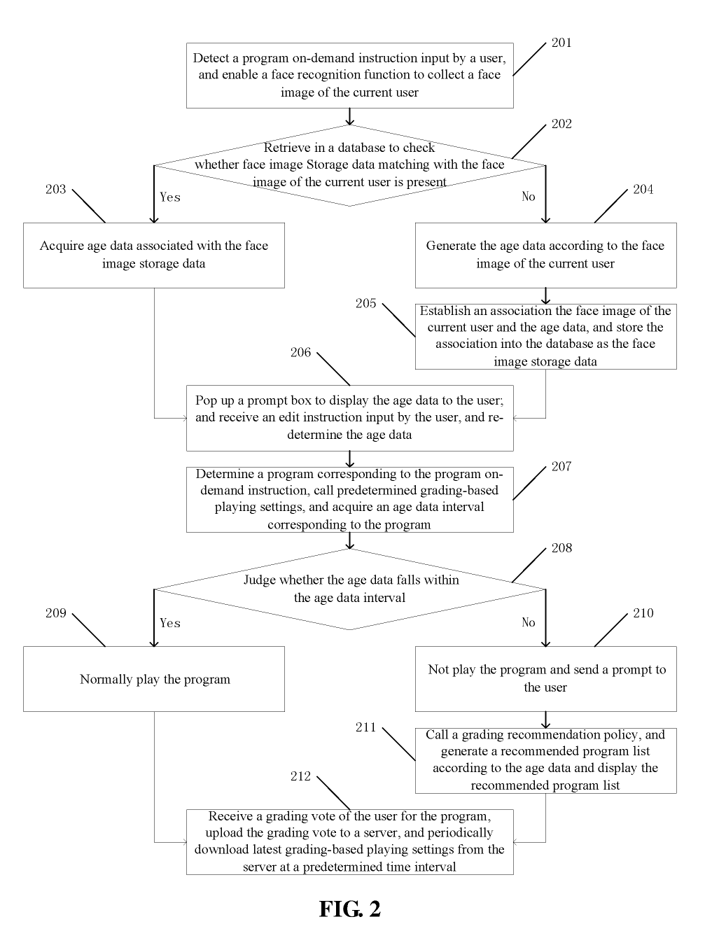

Referring to FIG. 2, a schematic flowchart illustrating a grading-based program playing method based on face recognition according to another embodiment of the present disclosure is given.

In a more specific embodiment, the grading-based program playing method based on face recognition includes the following steps:

Step 201: A program on-demand instruction input by a user is detected, and a face recognition function is enabled to collect a face image of the current user.

Step 202: A database is retrieved to check whether face image storage data matching with the face image of the current user is present; if the face image storage data matching with the face image of the current user is present, step 203 is performed; and otherwise, step 204 is performed.

In this embodiment, a database is configured locally on a smart terminal, wherein the database stores face image storage data which refers to face images and age data associated with the face image; a face recognition functional module of the smart terminal may collect face images of all the users who send a program on-demand instruction for watching programs, an association is established between face images and age data after the age data is generated according to the collected face images, and then the association is stored into the database as the face image storage data. In this way, when the users send a program on-demand instruction for watching programs, the age data of the users may be quickly acquired according to the face image storage data in the database.

The process of storing the face image data into the database in this step may be automatically performed when the smart terminal is in a normal working state, that is, the process of collecting the face image of the users using smart terminals, generating the age data and storing the face image and the age data into the database as the face image data may be automatically performed at the background. The above process is automatically performed for all the users using the smart terminals, to quickly and highly-efficiently establish the database.

The term “matching” in this step refers to that a face image in the face storage data stored in the database is the same as the collected face image of the current user, that is, face images of the same user.

Step 203: Age data associated with the face image storage data is acquired.

When it is determined that the face image storage data matching with the face image of the current user is present in the database by retrieving in the database, the age data of the current user is directly acquired the face image storage data matching with the face image of the user in the database.

Step 204: The age data is generated according to the face image of the current user.

When it is determined that the face image storage data matching with the face image of the current user is not present in the database by retrieving in the database, the age data of the current user is calculated in real time by using a predetermined face recognition algorithm based on the face image of the current user.

Step 205: An association is established between the face image of the current user and the age data, and the association is stored into the database as the face image storage data.

This step is performed after step 204 is performed. The age data of the current user generated in real time in step 204 is associated with the face image of the current user, and then the associated data is stored into the database as the face image storage data. When the user sends a program on-demand instruction for watching programs next time, the age data may be quickly acquired by retrieving in the database (the process of performing step 203).

Step 206: A prompt box is popped up to display the age data to the user; and an edit instruction input by the user is received, and the age data is re-determined.

After the age data of the current user is acquired through the above steps, the age data is displayed to the user by using a pop-up a prompt box, such that the user knows the age determined by the smart terminal. Considering that the face recognition function may have technical defects, or the face of the user is relatively young such that the age of the user determined by the smart terminal is deviated from the practical age of the user, a rectify and modify function may be further provided in this step. Preferably, an edit button is defined in the popped up prompt box. Upon receipt of a select instruction for the edit button from the user, an edit bar is popped up for the user to input an edit instruction for edit the age data; and the age data is re-determined according to the edit instruction input by the user.

Further, to prevent the young persons and children from modifying as desired the age data determined by the terminal, after the age data is displayed on the pop-up prompt box in this step, the method further includes a judgment process: judging whether the age data is greater that a predetermined threshold, if greater, further receiving an edit instruction input by the user, and otherwise, denying receiving the edit instruction input by the user. Generally, the predetermined threshold is defined to judge whether a user is at a age boundary between the young persons and the children, for example, 12 years old, 16 years old and the like. Through the above process, the user may edit the age data only when the user age determined by the smart determined is greater than the predetermined threshold.

Step 207: A program corresponding to the program on-demand instruction is determined, predetermined grading-based playing settings are called, and an age data interval corresponding to the program is acquired.

Step 208: It is judged whether the age data falls within the age data interval; if the age data falls within the age data interval, step 209 is performed; and otherwise, step 201 is performed.

Step 209: The program is normally played.

Step 210: The program is not played and a prompt is sent to the user.

Step 211: A grading recommendation policy is called, and a recommended program list is generated according to the age data and the recommended program list is displayed.

After step 210 is performed, if it is considered that the program which the user desires to watch is not suitable for watching, a program suitable for watching is further recommended to the user. Preferably, the grading recommendation policy is called, and the grading recommendation policy stores a list of programs which suitable for watching by users in different age intervals. A list of recommended programs is generated by using the called grading recommendation policy according to the age data of the current user acquired in the above step, and then the list of programs is displayed to the user for the user to select a program suitable for the age thereof and send a program on-demand instruction for watching the program.

Step 212: A grading vote of the user for the program is received, the grading vote is uploaded to a server, and latest grading-based playing settings are periodically downloaded from the server at a predetermined time interval.

After the user watches the demanded program, the user may judge an age interval which the program is suitable for from the perspective of the user and make a grading vote for the program. In this step, a grading vote of the user for the program is received, and the grading vote is uploaded to a server at a network end, wherein the grading vote is used for the server to generate latest grading-based playing settings. The server comprehensively process grading votes for different programs uploaded from various smart terminals to generate latest grading-based playing settings, wherein the latest grading-based playing settings may be provided for the smart terminal by means of downloading. To acquire and use the latest grading-based playing settings, in this step, the smart terminals download the latest grading-based playing settings from the server at a predetermined time interval, and the downloaded latest grading-based playing settings overwrite the locally stored original grading-based playing settings. In this step, by means of periodically downloading the latest grading-based playing settings, the effects of the grading-based program playing method are further ensured.

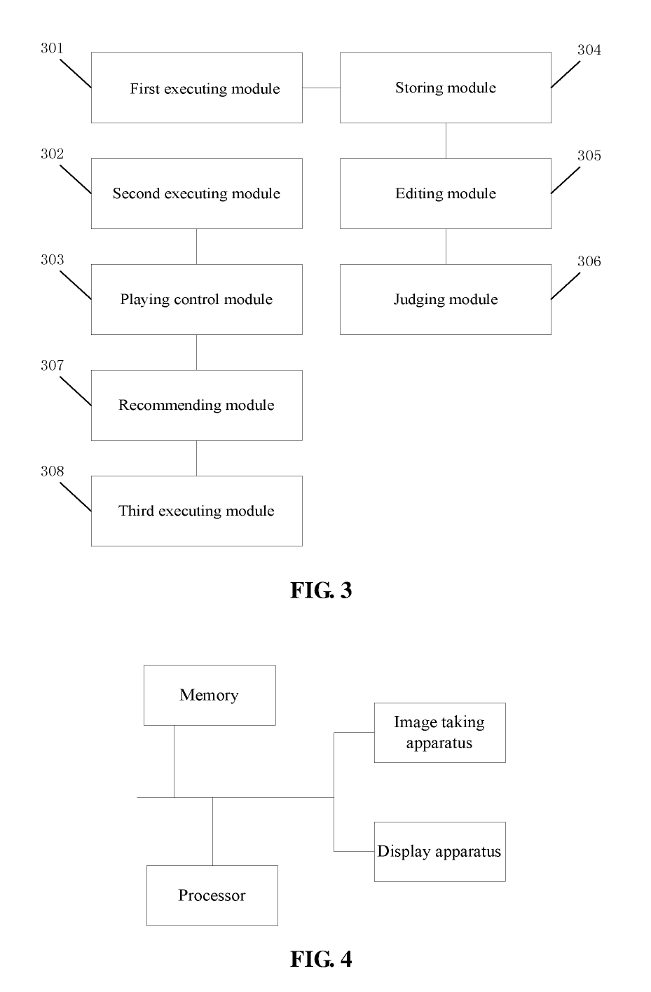

In another aspect, embodiments of the present disclosure further provide a grading-based program playing apparatus based on face recognition. Referring to FIG. 3, a schematic structural diagram illustrating a grading-based program playing apparatus based on face recognition according to one embodiment of the present disclosure is given.

The grading-based program playing apparatus based on face recognition includes:

a first executing module 301, configured to detect a program on-demand instruction input by a user, enable a face recognition function to collect a face image of the current user, and generate age data according to the face image of the current user;

a second executing module 302, configured to determine a program corresponding to the program on-demand instruction, call predetermined grading-based playing settings, and acquire an age data interval corresponding to the program; and

a playing control module 303, configured to judge whether the age data falls within the age data interval, if the age data falls within the age data interval, normally play the program, and otherwise, not play the program and sending a prompt to the user.

In an exemplary embodiment, the first executing module is further configured to retrieve in a database to check whether face image storage data matching with the face image of the current user is present, if the face image storage data matching with the face image of the current user is present, further acquire age data associated with the face image storage data, and otherwise, generate age data according to the face image of the current user.

In an exemplary embodiment, the grading-based program playing apparatus based on face recognition further includes: a storing module 304, configured to establish an association between the face image of the current user and the age data, and store the association into the database as the face image storage data.

In an exemplary embodiment, the grading-based program playing apparatus based on face recognition further includes: an editing module 305, configured to pop up a prompt box to display the age data to the user; and receive an edit instruction input by the user, and re-determine the age data.

In an exemplary embodiment, the grading-based program playing apparatus based on face recognition further includes: a judging module 306, configured to: judge whether the age data is greater than a predetermined threshold, if the age data is greater than the predetermined threshold, further receive the edit instruction input by the user, and otherwise, deny receiving the edit instruction input by the user.

In an exemplary embodiment, the grading-based program playing apparatus based on face recognition further includes: a recommending module 307, configured to call a grading recommendation policy, and generate a recommended program list according to the age data and display the recommended program list.

In an exemplary embodiment, the grading-based program playing apparatus based on face recognition further includes: a third executing module, configured to receive a grading vote of the user for the program, and upload the grading vote to a server, the grading vote being used for the server to generate latest grading-based playing settings; and periodically download the latest grading-based playing settings from the server at a predetermined time interval.

The grading-based program playing apparatus based on face recognition according to the above embodiment is configured to implement the above described grading-based program playing method based on face recognition, and achieves the beneficial effect of the corresponding method embodiments, which are thus not illustrated herein any further.

An embodiment of the present disclosure provides a non-volatile computer storage medium, wherein the computer storage medium stores computer executable instructions, which may be executed to perform the grading-based program playing method based on face recognition according to any one of the above method embodiments.

Referring to FIG. 4, a schematic structural diagram illustrating hardware of an electronic device for performing the grading-based program playing method based on face recognition according to an embodiment of the present disclosure is given. The electronic device includes:

The electronic device includes at least one processor and a memory, and FIG. 4 uses one processor as an example.

The electronic device for performing the grading-based program playing method based on face recognition may further include: an image taking apparatus and a displaying apparatus. The image taking apparatus may be configured to collect a face image of a current user, and the displaying apparatus may be configured to display play content and relevant prompt information.

The processor, the memory, the image taking apparatus and the displaying apparatus may be connected to each other via a bus or in another manner. FIG. 4 uses connection via a bus as an example for description.

The memory, as a non-volatile computer readable storage medium, may be configured to store non-volatile software programs, non-volatile computer executable programs and modules, for example, the program instructions/modules corresponding to the grading-based program playing methods based on face recognition in the embodiments of the present disclosure (for example, the playing control module, the editing module, the judging module and the like as illustrated in FIG. 3). The non-volatile software programs, instructions and modules stored in the memory, when being executed, cause the processor to perform various function applications and data processing of a server, that is, performing the grading-based program playing methods based on face recognition in the above method embodiments.

The memory may also include a program storage area and a data storage area. The program storage area may store an operating system and an application implementing at least one function. The data storage area may store the age data and the like generated according to the face image. In addition, the memory may include a high speed random access memory, or include a non-volatile memory, for example, at least one disk storage device, a flash memory device, or another non-volatile solid storage device. In some embodiments, the memory optionally includes memories remotely configured relative to the processor. These memories may be connected to the apparatus for processing item operations over a network. The above examples include, but not limited to, the Internet, Intranet, local area network, mobile communication network and a combination thereof.

The one or more modules are stored in the memory, and when being executed by the one or more processors, perform the grading-based program playing method based on face recognition in any of the above method embodiments.

The product may perform the method according to the embodiments of the present disclosure, has corresponding function modules for performing the method, and achieves the corresponding beneficial effects.

Persons of ordinary skill in the art should understand that the discussion of any of the above embodiments is exemplary, and is not intended to imply that the scope of the present disclosure (including the claims) is limited to these exemplary embodiments. The above embodiments, or the technical features in different embodiments may be combined, the steps may be performed in any sequence, and various modifications may be made to different aspects of the present disclosure, which are not described in detail for brevity. Therefore, any omission, modification, equivalent replacement, or improvement made without departing from the spirit and principle of the present disclosure should fall within the protection scope of the present disclosure.

What is claimed is:

1. A method for grading-based program playing based on face recognition, applied to a smart terminal, the method comprising:
detecting a program on-demand instruction input by a user, enabling a face recognition function to collect a face image of the current user, and generating age data according to the face image of the current user;
determining a program corresponding to the program on-demand instruction, calling predetermined grading-based playing settings, and acquiring an age data interval corresponding to the program; and
judging whether the age data falls within the age data interval, if the age data falls within the age data interval, normally playing the program, and otherwise, not playing the program and sending a prompt to the user.

2. The method according to claim 1, wherein upon the collecting a face image of the current user, the method further comprises:
retrieving in a database to check whether face image storage data matching with the face image of the current user is present, if the face image storage data matching with the face image of the current user is present, further acquiring age data associated with the face image storage data, and otherwise, generating age data according to the face image of the current user.

3. The method according to claim 2, wherein upon the generating age data according to the face image of the current user, the method further comprises:
establishing an association between the face image of the current user and the age data, and storing the association into the database as the face image storage data.

4. The method according to claim 1, wherein upon the generating age data according to the face image of the current user, the method further comprises:
popping up a prompt box to display the age data to the user; and
receiving an edit instruction input by the user, and re-determining the age data.

5. The method according to claim 4, wherein upon the popping up a prompt box to display the age data to the user, the method further comprises:
judging whether the age data is greater than a predetermined threshold, if the age data is greater than the predetermined threshold, further receiving the edit instruction input by the user, and otherwise, denying receiving the edit instruction input by the user.

6. The method according to claim 1, wherein upon the not playing the program and sending a prompt to the user, the method further comprises:
calling a grading recommendation policy, and generating a recommended program list according to the age data and displaying the recommended program list.

7. The method according to claim 1, further comprising:
receiving a grading vote of the user for the program, and uploading the grading vote to a server, the grading vote being used for the server to generate latest grading-based playing settings; and
periodically downloading the latest grading-based playing settings from the server at a predetermined time interval.

8. A non-volatile computer storage medium storing computer executable instructions, wherein the computer instructions are executed to:
detect a program on-demand instruction input by a user, enable a face recognition function to collect a face image of the current user, and generate age data according to the face image of the current user;
determine a program corresponding to the program on-demand instruction, call predetermined grading-based playing settings, and acquire an age data interval corresponding to the program; and
judge, according to a play instruction whether the age data falls within the age data interval, if the age data falls within the age data interval, normally play the program, and otherwise, not play the program and send a prompt to the user.

9. The non-volatile computer storage medium storing computer executable instructions according to claim 8, wherein upon the detecting a program on-demand instruction input by a user, enabling a face recognition function to collect a face image of the current user, and generating age data according to the face image of the current user, the computer executable instructions are further executed to:
retrieve in a database to check whether face image storage data matching with the face image of the current user is present, if the face image storage data matching with the face image of the current user is present, further acquire age data associated with the face image storage data, and otherwise, generate age data according to the face image of the current user.

10. The non-volatile computer storage medium storing computer executable instructions according to claim 8, wherein the computer executable instructions are further executed to:
store, according to a storage instruction, an association between the face image of the current user and the age data into the database as the face image storage data.

11. The non-volatile computer storage medium storing computer executable instructions according to claim 8, wherein the computer executable instructions are further executed to:
pop up a prompt box to display the age data to the user, and re-determine the age data according to an edit instruction input by the user.

12. The non-volatile computer storage medium storing computer executable instructions according to claim 11, wherein the computer executable instructions are further executed to:
judge, according to a judge instruction, whether the age data is greater than a predetermined threshold, if the age data is greater than the predetermined threshold, further receive the edit instruction input by the user, and otherwise, deny receiving the edit instruction input by the user.

13. The non-volatile computer storage medium storing computer executable instructions according to claim 8, wherein the computer executable instructions are further executed to:
call a grading recommendation policy according to a recommend instruction, and generate a recommended program list according to the age data and display the recommended program list.

14. The non-volatile computer storage medium storing computer executable instructions according to claim 8, wherein the computer executable instructions are further executed to:
receive a grading vote of the user for the program, and upload the grading vote to a server, the grading vote being used for the server to generate latest grading-based playing settings; and periodically download the latest grading-based playing settings from the server at a predetermined time interval.

15. An electronic device configured to perform a grading-based program playing method based on face recognition, comprising:
at least one processor; and
a memory communicably connected to the at least one processor; wherein
the memory stores instructions executable by the at least one processor, wherein, the instructions, when being executed by the at least one processor, causes the at least one processor to:
detect a program on-demand instruction input by a user, enable a face recognition function to collect a face image of the current user, and generate age data according to the face image of the current user;
determine a program corresponding to the program on-demand instruction, call predetermined grading-based playing settings, and acquire an age data interval corresponding to the program; and
judge, according to a play instruction whether the age data falls within the age data interval, if the age data falls within the age data interval, normally play the program, and otherwise, not play the program and send a prompt to the user.

16. The electronic device according to claim 15, wherein upon the detecting a program on-demand instruction input by a user, enabling a face recognition function to collect a face image of the current user, and generating age data according to the face image of the current user, the at least one processor is further caused to:
retrieve in a database to check whether face image storage data matching with the face image of the current user is present, if the face image storage data matching with the face image of the current user is present, further acquire age data associated with the face image storage data, and otherwise, generate age data according to the face image of the current user.

17. The electronic device according to claim 15, wherein the at least one processor is further caused to:
store, according to a storage instruction, an association between the face image of the current user and the age data into the database as the face image storage data.

18. The electronic device according to claim 15, wherein
the at least one processor is further caused to:
pop up a prompt box to display the age data to the user, and re-determine the age data according to an edit instruction input by the user.

19. The electronic device according to claim 15, wherein the at least one processor is further caused to:
call a grading recommendation policy according to a recommend instruction, and generate a recommended program list according to the age data and display the recommended program list.

20. The electronic device according to claim 15, wherein the at least one processor is further caused to:
receive a grading vote of the user for the program, and upload the grading vote to a server, the grading vote being used for the server to generate latest grading-based playing settings; and periodically download the latest grading-based playing settings from the server at a predetermined time interval.
